(19) United States
(12) Patent Application Publication
(10) Pub. No.: US 2006/0012894 A1
(43) Pub. Date: Jan. 19, 2006

(54) Method and apparatus for intelligent side-view mirrors for blind spot viewing

(76) Inventor: Gautam Sharma, Redondo Beach, CA (US)

Correspondence Address: Joseph S. Farzam, Esq., Suite 1770, 1875 Century Park East, Los Angeles, CA, 90067, US

(21) Appl. No.: 10/892,952

(22) Filed: Jul. 19, 2004

(51) Int. Cl. G02B 5/08

(52) U.S. Cl. 359/843; 359/871

(57) ABSTRACT

An apparatus and a method for intelligent side-view mirrors for blind spot viewing in a motor vehicle is presented. Upon manual activation, an indicator will transmit a signal to a positive pulse-triggered-timer. The pulse-triggered-timer will transmit an activation signal for X seconds to an activation relay. The activation relay will transmit a movement signal for X seconds to side-view mirror servomotors, which will move the side-view mirrors outward so as to enable the driver to view the blind spot. Upon manual deactivation, the indicator will transmit a signal to a negative pulse-triggered-timer. The negative pulse-triggered-timer will transmit a deactivation signal for X seconds to a deactivation relay. The deactivation relay will transmit a return signal for X seconds to side-view mirror servomotors which will move the side-view mirrors inward for X seconds returning them to the original position.

### BACKGROUND

(1) Technical Field

The present invention relates to the field of automotives safety, and more particularly to an apparatus and a method for intelligent side view mirrors for viewing blind spots.

(2) Discussion

Anyone who has ever operated a motor vehicle is readily familiar with the term “blind spot”. Blind spot is a zone that is invisible to a driver of a motor vehicle through the side-view and rear-view mirrors. Regardless of the angle and positioning of the mirror and irrespective of its concavity, any object located in the blind spot is completely invisible to a driver. Objects that are in advance of the blind spot or before it are visible and thus avoidable. Annually, thousand of accidents are attributed to the blind spot, such that a driver in an attempt to make a lane change, looks into the side-view mirror and sees nothing. Therefore, the driver erroneously assumes that there are no objects in the adjacent lane and proceeds to change lanes and therefore collides with the car in the next lane causing damage to property and injury to the person. The Department of Motor Vehicles manual of driver's safety suggests a driver must look over his shoulder before changing lanes so as to be able to avoid a collision with a car in the blind spot. This technique has not proven to be practical as most drivers find it too inconvenient to look over their shoulder before changing lanes.

Several inventions in the prior art have attempted to resolve the problem of blind spots. However, none is as functional and cost effective as the present invention. The present invention provides for an apparatus and a method for side-view mirrors that automatically and conveniently become activated when the driver attempts to change lanes. As a driver manually activates the left-turn or right-turn indicators, the system of present invention becomes activated, causing both mirrors to rotate outwards by a few degrees enabling perfect viewing of the blind spot. Upon deactivation of the left-turn or right-turn indicators the system deactivates as well, causing the mirrors to rotate inwards and return to their original position. The present invention is simple and cost effective. Most certainly every motor vehicle of the future will be equipped with this safety feature, thereby reducing the number of accidents on the road.

### SUMMARY

The present invention is an apparatus for intelligent side-view mirrors for blind spot viewing in a motor vehicle. Upon manual activation, an indicator will transmit a signal to a positive pulse-triggered-timer. The pulse-triggered-timer will transmit an activation signal for X seconds to an activation relay. The activation relay will transmit a movement signal for X seconds to side-view mirror servomotors, which will move the side-view mirrors outward so as to enable the driver to view the blind spot. Upon manual deactivation, the indicator will transmit a signal to a negative pulse-triggered-timer. The negative pulse-triggered-timer will transmit a deactivation signal for X seconds to a deactivation relay. The deactivation relay will transmit a return signal for X seconds to side-view mirror servomotors which will move the side-view mirrors inward for X seconds returning them to the original position.

The apparatus may be produced as a stand-alone device, or it may be integrated with a on or off switch which will enable activation or deactivation of the apparatus.

In a further embodiment, the apparatus further includes a system wherein the apparatus will switch on automatically when the motor vehicle reaches a certain pre-selected speed and the apparatus will switch off automatically when the motor vehicle's speed falls below the pre-selected speed.

The invention may also be embodied as a method for intelligent viewing of blind spots in a motor vehicle where the functionality of the above elements is captured by a series of steps. Further, the above elements may also represent means for performing their function, as will be discussed further herein.

### BRIEF DESCRIPTION OF THE DRAWINGS

These and other features, aspects, and advantages of the present invention will become better understood with regard to the following description, appended claims, and accompanying drawings where:

FIG. 1 is a pictorial representation of intelligent side view mirrors for viewing blind spots according to the present invention;

FIG. 2 is a process flow diagram that summarizes the method of intelligent viewing of blind spots according to the present invention.

### DETAILED DESCRIPTION

The present invention relates to the field of sound simulation, and more particularly to an apparatus and a method for simulating a wood burning sound from a wood burning fireplace simulator such as a gas fireplace. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In order to provide a working frame of reference, first a glossary of some of the terms used in the description and claims is given as a central resource for the reader. The glossary is intended to provide the reader with a “feel” for various terms as they are used in this disclosure, but is not intended to limit the scope of these terms. Rather, the scope of the terms is intended to be construed with reference to this disclosure as a whole and with respect to the claims below. Then, a brief introduction is provided in the form of a narrative description of the present invention to give a conceptual understanding prior to developing the specific details.

(1) Glossary

Before describing the specific details of the present invention, it is useful to provide a centralized location for various terms used herein and in the claims. The terms defined are as follows:

Indicator Switch—Indicator Switch is intended to be a switch which activates and deactivates the right-turn and left-turn indicators of a motor vehicle, alarming other cars of a move or a turn to the left or right. This device currently exists in every motor vehicle.

Pulse Triggered Timer—Pulse Triggered Timer is intended to be a timer that regulates the time a signal is transmitted from one element to another.

Servomotor—Servomotor as used herein is intended to be the elector-mechanical device that is attached to the side view mirrors regulating their movement and rotation.

X seconds—X seconds as used herein is intended to mean an unspecified time, which is pre-selected. Once X is determined, it remains constant throughout the application.

(2) Introduction

The present invention provides a mechanism through which a motor vehicle may be equipped with a system for viewing blind spots through side-view mirrors. In order to view the blind spots, upon manual activation, an indicator will transmit a signal to a positive pulse-triggered-timer. The pulse-triggered-timer will transmit an activation signal for X seconds to an activation relay. The activation relay will transmit a movement signal for X seconds to side-view mirror servomotors, which will move the side-view mirrors outward so as to enable the driver to view the blind spot. Upon manual deactivation, the indicator will transmit a signal to a negative pulse-triggered-timer. The negative pulse-triggered-timer will transmit a deactivation signal for X seconds to a deactivation relay. The deactivation relay will transmit a return signal for X seconds to side-view mirror servomotors which will move the side-view mirrors inward for X seconds returning them to the original position.

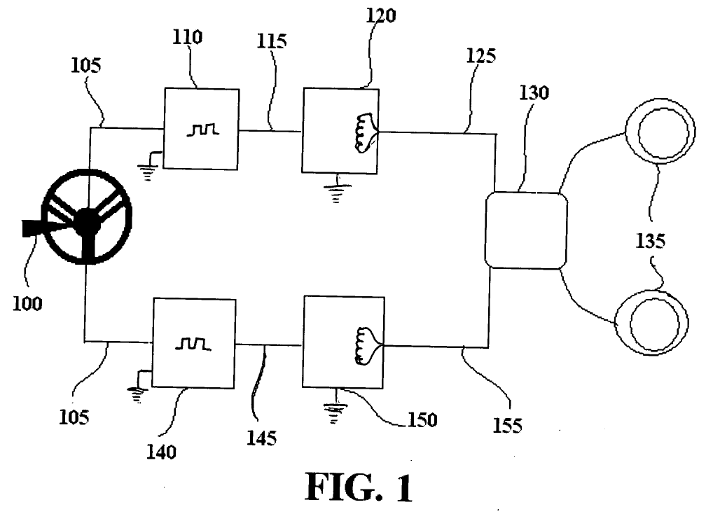

(3) Discussion
FIG. 1 is a pictorial representation of intelligent side view mirrors for viewing blind spots according to the present invention. An indicator 100 for warning the movement of a motor vehicle to the left or the right outputs a signal 105. A positive pulse-triggered-timer 110 connected with the indicator 100 receives the outputted signal 105 therefrom upon activation of the indicator 100 and transmits an activation signal 115 for X seconds. An activation relay 120 connected with the positive pulse-triggered-timer 110 receives the activation signal 115 and transmits a movement signal 125 for X seconds. A side-view mirror servomotor 130 connected with the activation relay 120 receives the movement signal 125 and moves side-view mirrors 135 outward for X seconds so as to enable the driver to view the blind spot.

A negative pulse-trigger-timer 140 connected with the indicator 100 receives the outputted signal 105 therefrom upon deactivation of the indicator and transmits a deactivation signal 145 for X seconds. A deactivation relay 150 connected with the negative pulse-triggered-timer 140 receives the deactivation signal 145 and transmits a return signal 155 for X seconds. The side-view mirror servomotor 130 connected with the deactivation relay 150 receives the return signal 155 and moves side-view mirrors 135 inward for X seconds returning them to the original position.

In another embodiment of the present invention, the present invention provides for a switch for switching the apparatus on and off as desired.

In yet another embodiment of the present invention, the present invention the apparatus will switch on automatically when the motor vehicle reaches a certain pre-selected speed and the apparatus will switch off automatically when the motor vehicle's speed falls below the pre-selected speed.

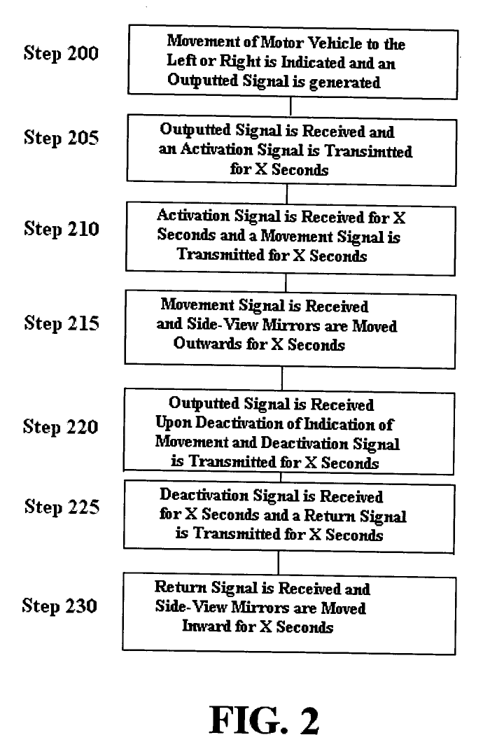

The present invention also comprises a method for simulating a wood-burning sound. FIG. 2 is a process flow diagram that summarizes the method of intelligent viewing of blind spots according to the present invention. In Step 200, the movement of a motor vehicle to the left or the right is indicated and an outputted signal is generated. In Step 205, the outputted signal is received upon activation of the indication of movement of a motor vehicle to the left or the right and an activation signal is transmitted for X seconds. In Step 210, the activation signal is received for X seconds and a movement signal is transmitted for X seconds. In Step 215 the movement signal is received and the side-view mirrors are moved outward for X seconds so as to enable the driver to view the blind spot.

In Step 220 the outputted signal is received upon deactivation of the indication of movement of a motor vehicle to the left or the right and a deactivation signal is transmitted for X seconds. In Step 225 the deactivation signal is received for X seconds and a return signal is transmitted for X seconds. In Step 230 the return signal is received and the side-view mirrors are moved inward for X seconds causing them to return to their original position.

In another embodiment of the present invention, it comprises a step of switching the method on or off as desired.

In another embodiment of the method of the present invention, it comprises a step of switching the method on automatically when the motor vehicle reaches a certain pre-selected speed and switching the method off automatically when the motor vehicle's speed falls below the pre-selected speed.

What is claimed is:

1. An apparatus for intelligent side-view mirrors for blind spot viewing in a motor vehicle, the apparatus comprising:
a. an indicator switch for warning the movement of a motor vehicle to the left or the right and for outputting a signal;
b. a positive pulse-triggered-timer connected with the indicator to receive the outputted signal therefrom upon activation of the indicator and to transmit an activation signal for X seconds;
c. an activation relay connected with the positive pulse-triggered-timer to receive the activation signal and to transmit a movement signal for X seconds;
d. a side-view mirror servomotor connected with the activation relay to receive the movement signal and to move side-view mirrors outward for X seconds so as to enable the driver to view the blind spot;
e. a negative pulse-trigger-timer connected with the indicator to receive the outputted signal therefrom upon deactivation of the indicator and to transmit a deactivation signal for X seconds;
f. a deactivation relay connected with the negative pulse-triggered-timer to receive the deactivation signal and to transmit a return signal for X seconds; and
g. the side-view mirror servomotor connected with the deactivation relay to receive the return signal and to move side-view mirrors inward for X seconds returning them to the original position such that upon manual activation, the indicator will transmit the signal to the positive pulse-triggered-timer which will in turn transmit the activation signal for X seconds to the activation relay which will then transmit the movement signal for X seconds to the side-view mirror servomotor which will move the side-view mirrors outward so as to enable the driver to view the blind spot and upon manual deactivation, the indicator will transmit the signal to the negative pulse-triggered-timer which will in turn transmit the deactivation signal for X seconds to the deactivation relay which will then transmit the return signal for X seconds to the side-view mirror servomotor which will move the side-view mirrors inward for X seconds returning them to the original position.

2. An apparatus for intelligent side-view mirrors for blind spot viewing in a motor vehicle as set forth in claim 1, the apparatus further comprising a switch for switching the apparatus on and off as desired.

3. An apparatus for intelligent side-view mirrors for blind spot viewing in a motor vehicle as set forth in claim 2, wherein the apparatus will switch on automatically when the motor vehicle reaches a certain pre-selected speed and the apparatus will switch off automatically when the motor vehicle's speed falls below the pre-selected speed.

4. A method for intelligent side-view mirrors for blind spot viewing, the method comprising the steps of:
a. indicating the movement of a motor vehicle to the left or the right and generating an outputted signal;
b. receiving the outputted signal upon activation of the indication of movement of a motor vehicle to the left or the right and transmitting an activation signal for X seconds;
c. receiving the activation signal for X seconds and transmitting a movement signal for X seconds;
d. receiving the movement signal and moving the side-view mirrors outward for X seconds so as to enable the driver to view the blind spot;
e. receiving the outputted signal upon deactivation of the indication of movement of a motor vehicle to the left or the right and transmitting a deactivation signal for X seconds;
f. receiving the deactivation signal for X seconds and transmitting a return signal for X seconds;
g. receiving the return signal and moving the side-view mirrors inward for X seconds returning them to their original position such that upon manual activation of the indication of movement of a motor vehicle to the left or the right, outputted signal is generated and received and then activation signal is transmitted for X seconds which is then received for X seconds and movement signal is transmitted for X seconds and received thereby moving the side-view mirrors outward for X seconds so as to enable the driver to view the blind spot and then upon deactivation of the indication of movement of a motor vehicle to the left or right an outputted signal is received and an deactivation signal is transmitted for X seconds which is then received and then deactivation signal is transmitted for X seconds which is then received for X seconds and return signal is transmitted for X seconds and received thereby moving the side-view mirrors inward for X seconds returning them to their original position.

5. A method for intelligent side-view mirrors for blind spot viewing in a motor vehicle as set forth in claim 4, the method further comprising a step of switching the method on or off as desired.

6. A method for intelligent side-view mirrors for blind spot viewing in a motor vehicle as set forth in claim 5, wherein the method further comprising a step of switching the method on automatically when the motor vehicle reaches a certain pre-selected speed and switching the method off automatically when the motor vehicle's speed falls below the pre-selected speed.
